(19) United States
(12) Patent Application Publication
(10) Pub. No.: US 2023/0354115 A1
(43) Pub. Date: Nov. 2, 2023

(54) LAYER 1 / LAYER 2 SIGNALING FOR INTER-CELL MOBILITY WITH MULTIPLE TRANSMISSION RECEPTION POINTS

(71) Applicant: QUALCOMM Incorporated, San Diego, CA (US)

(72) Inventors: Jelena DAMNJANOVIC, Del Mar, CA (US); Mostafa KHOSHNEVISAN, San Diego, CA (US); Yan ZHOU, San Diego, CA (US); Tao LUO, San Diego, CA (US); Aleksandar DAMNJANOVIC, Del Mar, CA (US)

(21) Appl. No.: 17/661,131

(22) Filed: Apr. 28, 2022

(51) Int. Cl. H04W 36/00; H04W 36/08; H04W 24/02

(52) U.S. Cl. CPC H04W 36/0069; H04W 24/02; H04W 36/0011; H04W 36/08

(57) ABSTRACT

Various aspects of the present disclosure generally relate to wireless communication. In some aspects, a network node may receive configuration information, the configuration information indicating that a Layer 1 / Layer 2 (L1/L2) control signal is to be used to indicate when the network node is to: switch from additional transmission reception point (TRP) functionality to primary TRP functionality for a primary serving cell, or switch from a secondary serving cell to the primary serving cell and activate the primary TRP functionality. The network node may receive the L1/L2 control signal. The network node may activate, based at least in part on the L1/L2 control signal, the primary TRP functionality. Numerous other aspects are described.

### FIELD OF THE DISCLOSURE

Aspects of the present disclosure generally relate to wireless communication and to techniques and apparatuses for layer 1 / layer 2 (L1/L2) signaling for inter-cell mobility with multiple transmission reception points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a WiFi link, or a Bluetooth link).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a device. The method may include receiving configuration information, the configuration information indicating that a Layer 1 / Layer 2 (L1/L2) control signal is to be used to indicate when the device is to switch from additional transmission reception point (TRP) functionality to primary TRP functionality for a primary serving cell, or switch from a secondary serving cell to the primary serving cell and activate the primary TRP functionality. The method may include receiving the L1/L2 control signal. The method may include activating, based at least in part on the L1/L2 control signal, the primary TRP functionality.

Some aspects described herein relate to a method of wireless communication performed by a network node. The method may include providing configuration information, the configuration information indicating that an L1/L2 control signal is to be used to indicate when a TRP is to switch from additional TRP functionality to primary TRP functionality for a primary serving cell, or switch from a secondary serving cell to the primary serving cell and activate the primary TRP functionality. The method may include determining that one or more conditions for the TRP to switch functionality are satisfied. The method may include providing, based at least in part on the determination, the L1/L2 control signal.

Some aspects described herein relate to a device for wireless communication. The device may include a memory and one or more processors coupled to the memory. The one or more processors may be configured to receive configuration information, the configuration information indicating that an L1/L2 control signal is to be used to indicate when the device is to switch from additional TRP functionality to primary TRP functionality for a primary serving cell, or switch from a secondary serving cell to the primary serving cell and activate the primary TRP functionality. The one or more processors may be configured to receive the L1/L2 control signal. The one or more processors may be configured to activate, based at least in part on the L1/L2 control signal, the primary TRP functionality.

Some aspects described herein relate to a network node for wireless communication. The network node may include a memory and one or more processors coupled to the memory. The one or more processors may be configured to provide configuration information, the configuration information indicating that an L1/L2 control signal is to be used to indicate when a TRP is to switch from additional TRP functionality to primary TRP functionality for a primary serving cell, or switch from a secondary serving cell to the primary serving cell and activate the primary TRP functionality. The one or more processors may be configured to determine that one or more conditions for the TRP to switch functionality are satisfied. The one or more processors may be configured to provide, based at least in part on the determination, the L1/L2 control signal.

Some aspects described herein relate to a non-transitory computer-readable medium that stores a set of instructions for wireless communication by a device. The set of instructions, when executed by one or more processors of the device, may cause the device to receive configuration information, the configuration information indicating that an L1/L2 control signal is to be used to indicate when the device is to switch from additional TRP functionality to primary TRP functionality for a primary serving cell, or switch from a secondary serving cell to the primary serving cell and activate the primary TRP functionality. The set of instructions, when executed by one or more processors of the device, may cause the device to receive the L1/L2 control signal. The set of instructions, when executed by one or more processors of the device, may cause the device to activate, based at least in part on the L1/L2 control signal, the primary TRP functionality.

Some aspects described herein relate to a non-transitory computer-readable medium that stores a set of instructions for wireless communication by a network node. The set of instructions, when executed by one or more processors of the network node, may cause the network node to provide configuration information, the configuration information indicating that an L1/L2 control signal is to be used to indicate when a TRP is to switch from additional TRP functionality to primary TRP functionality for a primary serving cell, or switch from a secondary serving cell to the primary serving cell and activate the primary TRP functionality. The set of instructions, when executed by one or more processors of the network node, may cause the network node to determine that one or more conditions for the TRP to switch functionality are satisfied. The set of instructions, when executed by one or more processors of the network node, may cause the network node to provide, based at least in part on the determination, the L1/L2 control signal.

Some aspects described herein relate to an apparatus for wireless communication. The apparatus may include means for receiving configuration information, the configuration information indicating that an L1/L2 control signal is to be used to indicate when the device is to switch from additional TRP functionality to primary TRP functionality for a primary serving cell, or switch from a secondary serving cell to the primary serving cell and activate the primary TRP functionality, means for receiving the L1/L2 control signal, and means for activating, based at least in part on the L1/L2 control signal, the primary TRP functionality.

Some aspects described herein relate to an apparatus for wireless communication. The apparatus may include means for providing configuration information, the configuration information indicating that an L1/L2 control signal is to be used to indicate when a TRP is to switch from additional TRP functionality to primary TRP functionality for a primary serving cell, or switch from a secondary serving cell to the primary serving cell and activate the primary TRP functionality, means for determining that one or more conditions for the TRP to switch functionality are satisfied, and means for providing, based at least in part on the determination, the L1/L2 control signal.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of an O-RAN architecture, in accordance with the present disclosure, in accordance with the present disclosure.

FIG. 4 illustrates an example logical architecture of a distributed RAN including multiple TRPs, in accordance with the present disclosure.

FIG. 5 is a diagram illustrating an example of multi-TRP communication, in accordance with the present disclosure.

FIG. 6 is a diagram illustrating examples of carrier aggregation, in accordance with the present disclosure.

FIG. 7 is a diagram illustrating an example associated with L1/L2 signaling for inter-cell mobility with multiple transmission reception points, in accordance with the present disclosure.

FIG. 8 is a diagram illustrating an example associated with cells with different statuses with respect to carrier aggregation and L1/L2 signaling capabilities and configurations, in accordance with the present disclosure.

FIGS. 9-10 are diagrams illustrating example processes associated with L1/L2 signaling for inter-cell mobility with multiple TRPs, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

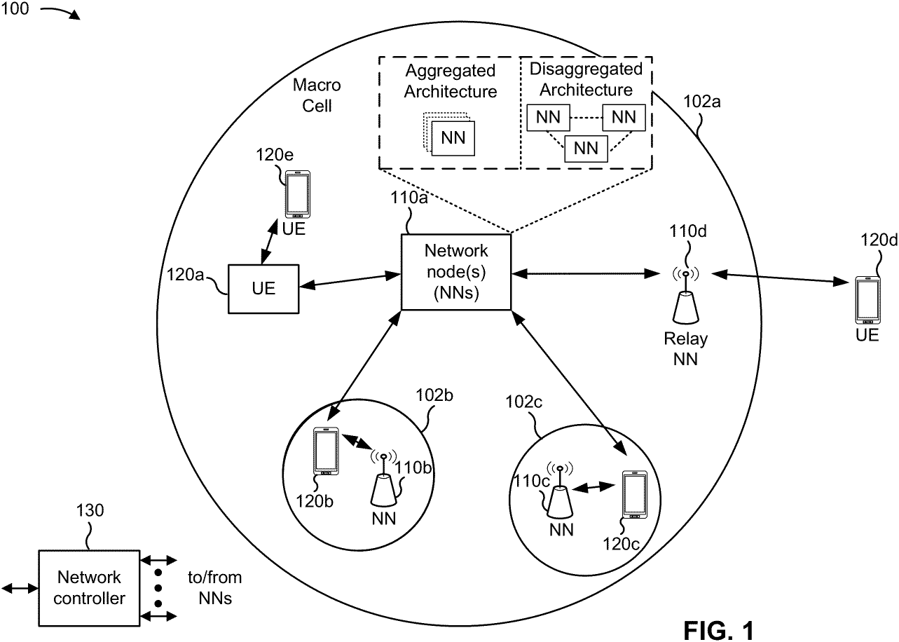

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 includes two or more non-co-located network nodes. A disaggregated network node may be configured to utilize a protocol stack that is physically or logically distributed among two or more nodes (such as one or more central units (CUs), one or more distributed units (DUs), or one or more radio units (RUs)).

In some examples, a network node 110 includes an entity that communicates with UEs 120 via a radio access link, such as a radio unit (RU). In some examples, a network node 110 includes an entity that communicates with other network nodes 110 via a fronthaul link or a midhaul link, such as a distributed unit (DU). In some examples, a network node 110 includes an entity that communicates with other network nodes 110 via a midhaul link or a core network via a backhaul link, such as a central unit (CU). In some aspects, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another and/or to one or more other network nodes 110 in the wireless network 100 through various types of fronthaul, midhaul, or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a base station and/or a base station subsystem serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A base station may support one or multiple (e.g., three) cells.

In some examples, a cell may not necessarily be stationary, and the geographic area of the cell may move according to the location of a network node 110 that is mobile (e.g., a mobile base station).

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120 or network nodes 110. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay node, a relay, or the like.

The wireless network 100 may be a heterogeneous network that includes network nodes 110 of different types, such as macro base stations, pico base stations, femto base stations, relay base stations, TRPs, RUs, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul or midhaul communication link. The network nodes 110 may communicate with one another directly or indirectly via a wireless or wireline backhaul communication link. In some aspects, the network controller 130 may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

As described herein, communication of information (e.g., any information, signal, or the like) may be described in various aspects using different terminology, such as “transmit,” “provide,” “output,” “receive” “obtain,” and “decode,” among other examples. Disclosure of one of these communication terms includes disclosure of other of these communication terms. For example, a first network node 110 may be described as being configured to transmit information to a second network node 110. In this example and consistent with this disclosure, disclosure that the first network node 110 is configured to transmit information to the second network node 110 includes disclosure that the first network node 110 is configured to provide, send, output, communicate, or transmit information to the second network node 110. Similarly, in this example and consistent with this disclosure, disclosure that the first network node 110 is configured to transmit information to the second network node 110 includes disclosure that the second network node 110 is configured to receive, obtain, or decode the information that is provided, sent, output, communicated, or transmitted by the first network node 110.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz —- 7.125 GHz) and FR2 (24.25 GHz — 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz — 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz — 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz — 114.25 GHz), and FR5 (114.25 GHz — 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

Deployment of communication systems, such as 5G NR systems, may be arranged in multiple manners with various components or constituent parts. In a 5G NR system, or network, a network node may be implemented in an aggregated or disaggregated architecture. For example, a network node, or one or more units (or one or more components) performing network node functionality, may be implemented as an aggregated network node (sometimes referred to as a standalone base station or a monolithic base station) or a disaggregated network node. “Network entity” or “network node” may refer to a disaggregated network node, an aggregated network node, or one or more entities of a disaggregated network node (such as one or more CUs, one or more DUs, one or more RUs, or a combination thereof).

In some aspects, a CU may be implemented within a RAN node (e.g., a network node 110), and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of network node functionality. For example, disaggregated network nodes may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated network node may include functionality implemented across two or more units at various physical locations, as well as functionality implemented for at least one unit virtually, which may enable flexibility in network design.

In some aspects, the device may include a communication manager. As described in more detail elsewhere herein, the communication manager may receive configuration information, the configuration information indicating that an L1/L2 control signal is to be used to indicate when the device is to: switch from additional TRP functionality to primary TRP functionality for a primary serving cell, or switch from a secondary serving cell to the primary serving cell and activate the primary TRP functionality; receive the L1/L2 control signal; and activate, based at least in part on the L1/L2 control signal, the primary TRP functionality. Additionally, or alternatively, the communication manager 150 may perform one or more other operations described herein.

In some aspects, the network node may include a communication manager 150. As described in more detail elsewhere herein, the communication manager 150 may provide configuration information, the configuration information indicating that an L1/L2 control signal is to be used to indicate when a TRP is to: switch from additional TRP functionality to primary TRP functionality for a primary serving cell, or switch from a secondary serving cell to the primary serving cell and activate the primary TRP functionality; determine that one or more conditions for the TRP to switch functionality are satisfied; and provide, based at least in part on the determination, the L1/L2 control signal. Additionally, or alternatively, the communication manager 150 may perform one or more other operations described herein.

As indicated above, FIG. 1 is provided as an example. Other examples may differ from what is described with regard to FIG. 1.

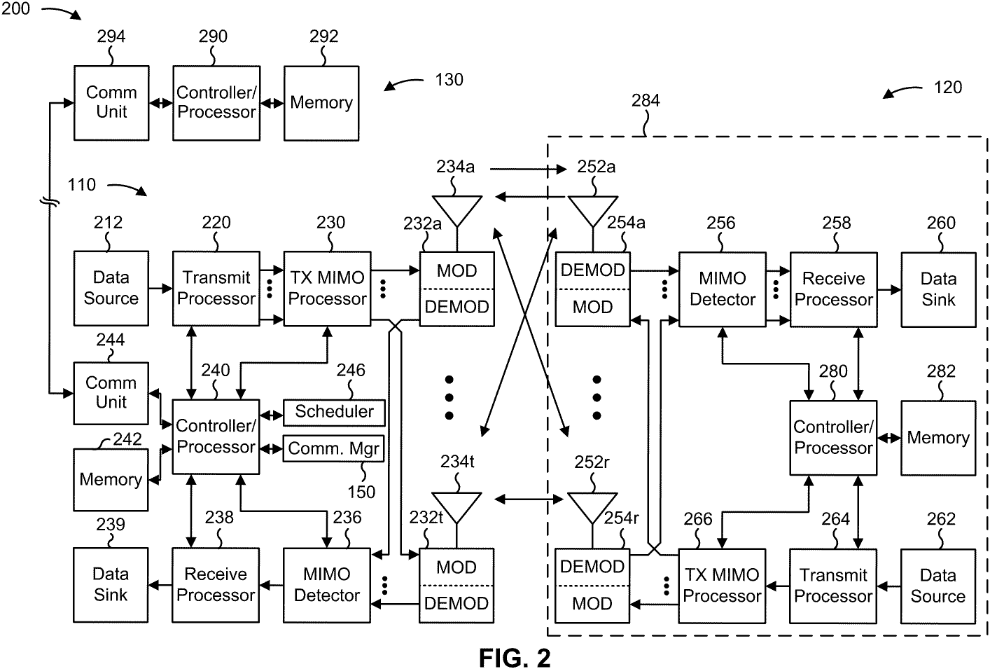

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥ 1). The UE 120 may be equipped with a set of antennas 252a through 252r, such as R antennas (R ≥ 1). The network node 110 of example 200 includes one or more radio frequency components, such as antennas 234 and a modem 254. In some examples, a network node 110 may include an interface, a communication component, or another component that facilitates communication with the UE 120 or another network node. For example, some network nodes 110 may not include radio frequency components.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., Tmodems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

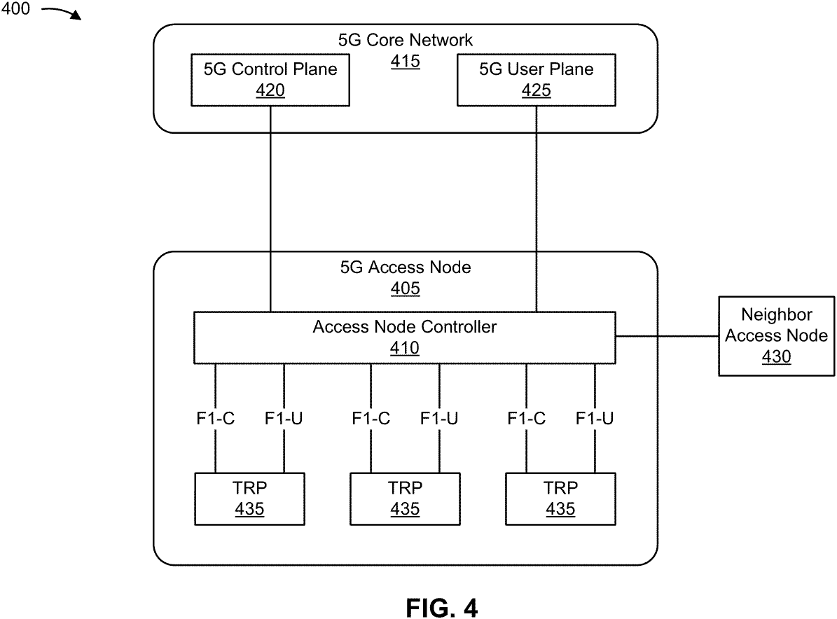

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

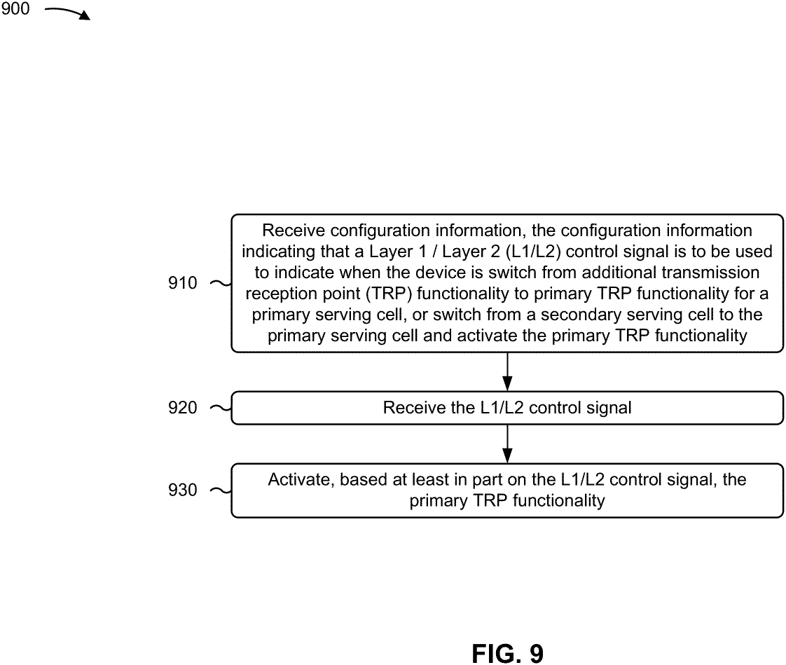

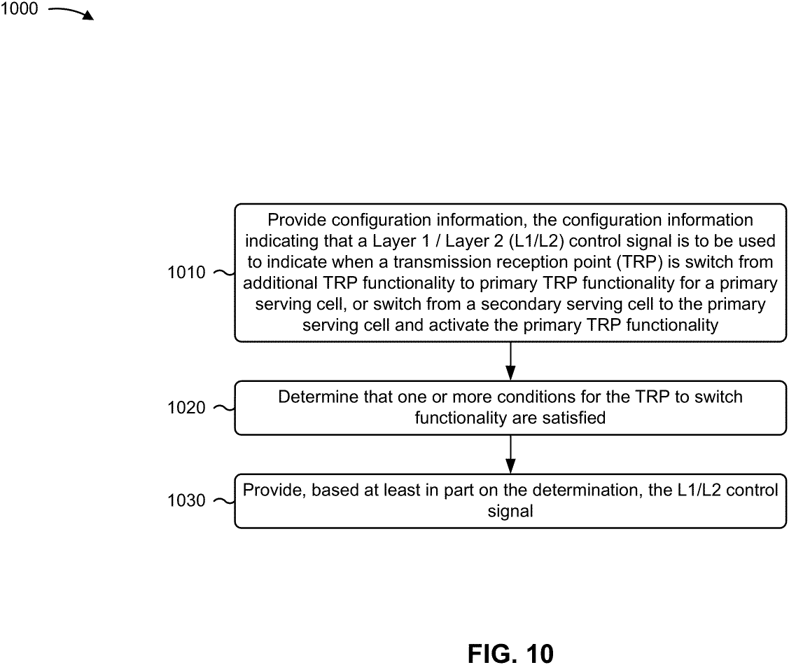

The controller/processor 240 of the network node 110, the controller/processor 280 of the UE 120, and/or any other component(s) of FIG. 2 may perform one or more techniques associated with L1/L2 signaling for inter-cell mobility with multiple TRPs, as described in more detail elsewhere herein. For example, the controller/processor 240 of the network node 110, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the network node includes means for receiving configuration information, the configuration information indicating that an L1/L2 control signal is to be used to indicate when the device is to: switch from additional TRP functionality to primary TRP functionality for a primary serving cell, or switch from a secondary serving cell to the primary serving cell and activate the primary TRP functionality; means for receiving the L1/L2 control signal; and/or means for activating, based at least in part on the L1/L2 control signal, the primary TRP functionality. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node includes means for providing configuration information, the configuration information indicating that an L1/L2 control signal is to be used to indicate when a TRP is to: switch from additional TRP functionality to primary TRP functionality for a primary serving cell, or switch from a secondary serving cell to the primary serving cell and activate the primary TRP functionality; means for determining that one or more conditions for the TRP to switch functionality are satisfied; and/or means for providing, based at least in part on the determination, the L1/L2 control signal. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

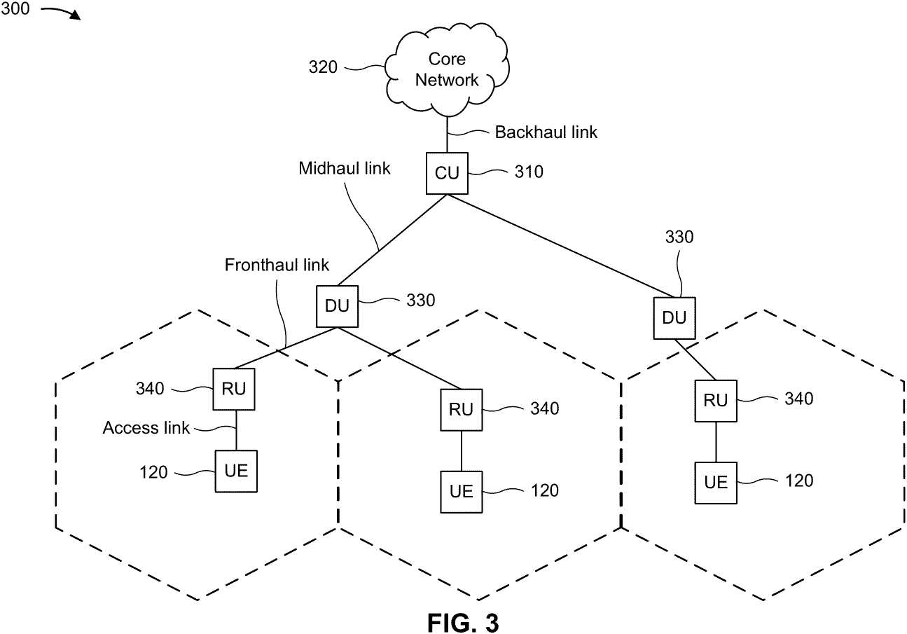

FIG. 3 is a diagram illustrating an example 300 of an O-RAN architecture, in accordance with the present disclosure. As shown in FIG. 3, the O-RAN architecture may include a CU 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a network node 110 (e.g., an eNB or a gNB) is provided by a DU 330 and one or more RUs 340 that communicate over a fronthaul link. Accordingly, as described herein, a network node 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

FIG. 4 illustrates an example logical architecture of a distributed RAN 400 including multiple TRPs, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a distributed unit (DU) of the distributed RAN 400. In some aspects, a TRP 435 may correspond to a network node 110 described above in connection with FIG. 1. For example, different TRPs 435 may be included in different network nodes 110, or different base stations. Additionally, or alternatively, multiple TRPs 435 may be included in a single network node 110, or a single base station. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

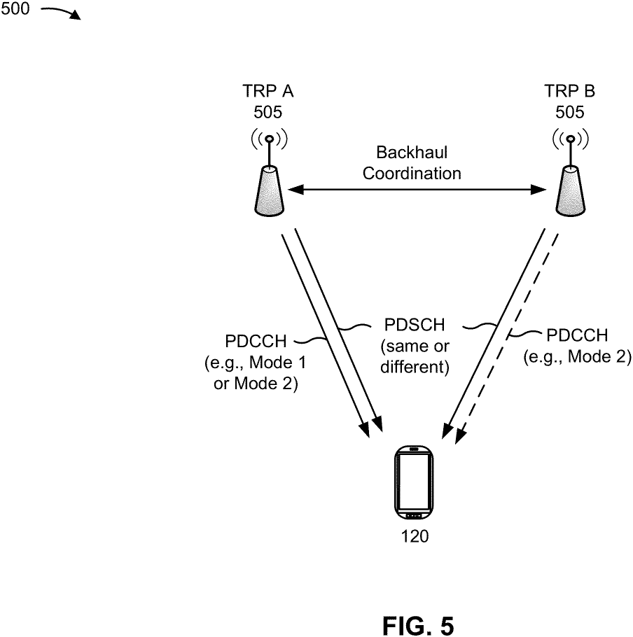

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 or base station (e.g., when the TRPs 505 are different antenna arrays or panels of the same base station), and may have a larger delay and/or lower capacity (as compared to co-location) when the TRPs 505 are located at different network nodes 110 or base stations. The different TRPs 505 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

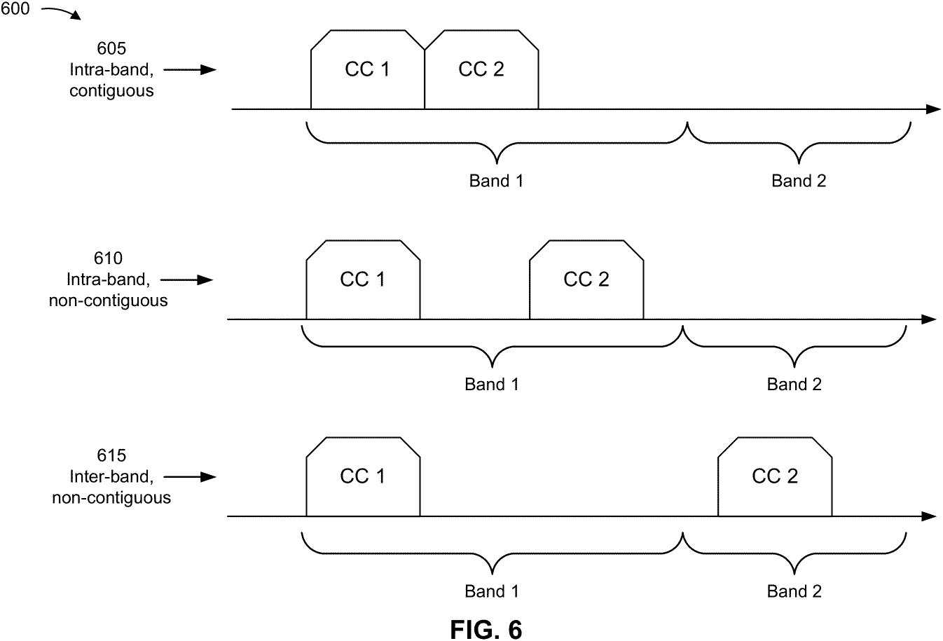

FIG. 6 is a diagram illustrating examples 600 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a radio resource control (RRC) message, downlink control information (DCI), and/or another signaling message.

As shown by reference number 605, in some aspects, carrier aggregation may be configured in an intra-band contiguous mode where the aggregated carriers are contiguous to one another and are in the same band. As shown by reference number 610, in some aspects, carrier aggregation may be configured in an intra-band non-contiguous mode where the aggregated carriers are non-contiguous to one another and are in the same band. As shown by reference number 615, in some aspects, carrier aggregation may be configured in an inter-band non-contiguous mode where the aggregated carriers are non-contiguous to one another and are in different bands.

In carrier aggregation, a UE 120 may be configured with a primary carrier or primary serving cell (PCell) and one or more secondary carriers or secondary serving cells (SCells). In some aspects, the PCell may carry control information (e.g., downlink control information and/or scheduling information) for scheduling data communications on one or more SCells, which may be referred to as cross-carrier scheduling. In some aspects, a carrier (e.g., a PCell or an SCell) may carry control information for scheduling data communications on the carrier, which may be referred to as self-carrier scheduling or carrier self-scheduling.

When carrier aggregation is used in a multi-TRP environment, multiple TRPs may be associated with the same cell (e.g., a PCell or an SCell), as they may operate intra-band (e.g., in the same component carrier), but have distinct physical cell identifiers (PCIs). In this situation, a PCell may have a primary TRP (pTRP) and one or more additional TRPs (aTRPs), where the pTRP carries control information and/or scheduling information for the intra-band aTRPs (if used) and/or the inter-band SCell(s). When channel conditions associated with the PCell change for a UE (e.g., based on the UE being mobile, network interference, cellular load, and/or the like), a handover (e.g., to an aTRP in the PCell or another TRP in an SCell) may be performed to improve communications between the cells and the UE. However, to change the pCell and/or pTRP, layer 3 (L3) signaling (e.g., via RRC) may be required to perform a handover. An L3 handover may use more resources (e.g., time resources, processing resources, and/or the like) than lower layer (e.g., L1/L2) signaling, which may introduce latency during the handover. The latency involved in an L3 handover may result in interruptions and/or reduced quality of service to UEs being served by a network, especially in situations where UEs are mobile and/or when channel conditions may otherwise rapidly change.

As indicated above, FIG. 6 is provided as an example. Other examples may differ from what is described with regard to FIG. 6.

Some techniques and apparatuses described herein enable L1/L2 signaling for inter-cell mobility with multiple TRPs. For example, a network node may selectively configure TRPs with the ability to switch from aTRP functionality to pTRP functionality, or to switch from an SCell to a PCell and activate pTRP functionality. The switch may be activated by an L1/L2 control signal (e.g., via MAC CE or DCI). In this way, a new pTRP within a PCell may change, and/or an SCell may become a PCell (including activation of a new pTRP) using L1/L2 signaling and without relying on an L3 handover. As a result, the process for changing a pTRP and/or PCell may be more efficient, using fewer resources (including time resources and processing resources), involving fewer devices (e.g., without using a CU to signal a switch), and introducing less latency than other methods, such as an L3 handover. The efficient process, with less latency, may improve network conditions for UEs operating on a network, including a network that uses multi-TRP functionality and carrier aggregation.

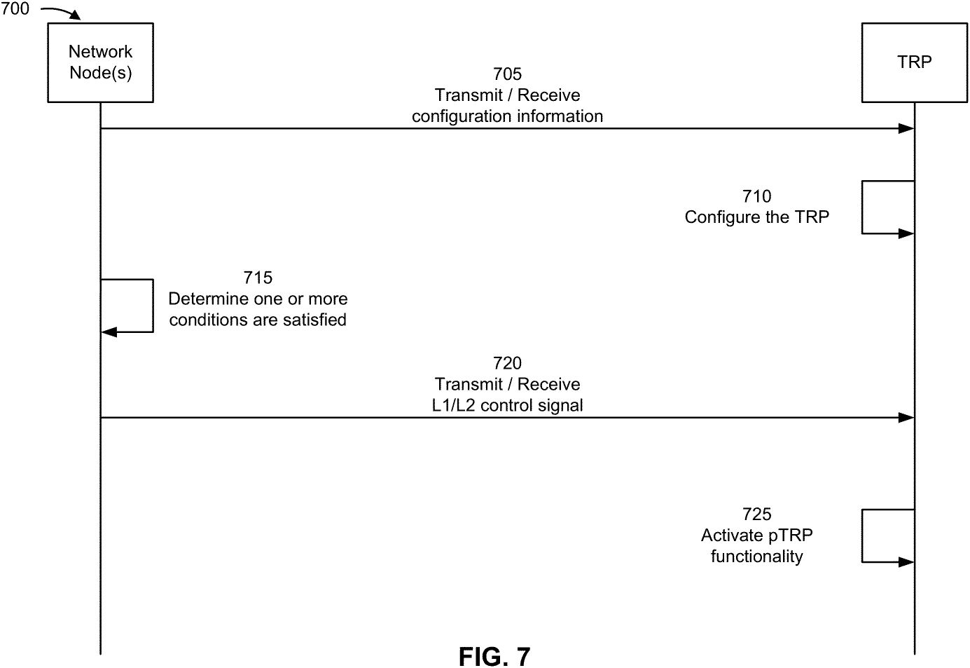

FIG. 7 is a diagram of an example 700 associated with L1/L2 signaling for inter-cell mobility with multiple transmission reception points, in accordance with the present disclosure. As shown in FIG. 7, one or more network nodes (e.g., network nodes 110) may communicate with a TRP (e.g., another network node 110). The network nodes may include one or more network nodes 110, such as one or more base stations, one or more CUs, one or more DUs, one or more RUs, one or more core network nodes, one or more network servers, one or more application servers, and/or one or more access and mobility management functions (AMFs), among other examples. In some aspects, the TRP and a network node of the multiple network nodes may be part of a wireless network (e.g., wireless network 100). The TRP and the network node may have established a wireless connection prior to operations shown in FIG. 7.

As shown by reference number 705, the network node may transmit, and the TRP may receive, configuration information. In some aspects, the TRP may receive the configuration information via one or more of radio resource control (RRC) signaling, one or more medium access control (MAC) control elements (CEs), and/or downlink control information (DCI), among other examples. For example, the configuration information may be provided by a CU to the TRP via RRC signaling. In some aspects, the configuration information may include an indication of one or more configuration parameters (e.g., already known to the TRP and/or previously indicated by the network node or other network device) for selection by the TRP, and/or explicit configuration information for the TRP to use to configure the TRP, among other examples.

In some aspects, the configuration information may indicate that the TRP is to, based at least in part on receipt of an L1/L2 control signal (e.g., a MAC CE, DCI, and/or the like), switch from aTRP functionality to pTRP functionality for a PCell, or switch from an SCell to the PCell and activate pTRP functionality.

In some aspects, the network node may determine that the TRP is to receive the configuration information based at least in part on a capability of the TRP, and/or channel conditions associated with the TRP. For example, a TRP may not be capable of pTRP functionality, not be capable of pTRP functionality in combination with carrier aggregation, and/or the like. As another example, the TRP may be associated with channel conditions (e.g., cellular load, signal quality, and/or the like) that indicate the TRP is not a good candidate for acting as a PCell and/or a pTRP (e.g., for a specific UE and/or for multiple UEs). In this situation, the network node may provide the configuration information based at least in part on the capabilities of the TRP and/or channel conditions associated with the TRP.

As shown by reference number 710, the TRP may configure itself based at least in part on the configuration information. In some aspects, the TRP may be configured to perform one or more operations described herein based at least in part on the configuration information. For example, the TRP may configure itself to, based at least in part on receipt of an L1/L2 control signal (e.g., a MAC CE, DCI, and/or the like), switch from aTRP functionality to pTRP functionality for a PCell, or switch from an SCell to the PCell and activate pTRP functionality.

As shown by reference number 715, the network node may determine whether one or more conditions for the TRP to switch functionality are satisfied. For example, before providing a signal that causes the TRP to switch functionality, the network node may determine if the UE should switch the PCell and/or pTRP with which the UE communicates. In some aspects, the one or more conditions may be associated with the channel conditions of the PCell, the SCell, the TRP, and/or other TRPs in the PCell or SCell. For example, the conditions may be associated with one or more thresholds that should be satisfied before the switch is signaled, such as a reference signal received power (RSRP) threshold, a signal-to-interference-plus-noise ratio (SINR) threshold, a cellular load threshold, and/or the like. The thresholds may be measured with respect to any of the PCell, the SCell, the TRP, and/or other TRPs in the PCell or SCell. This may enable the network node to determine whether a current PCell and/or TRP should be changed, and which SCell and/or TRP should become the new PCell and/or pTRP.

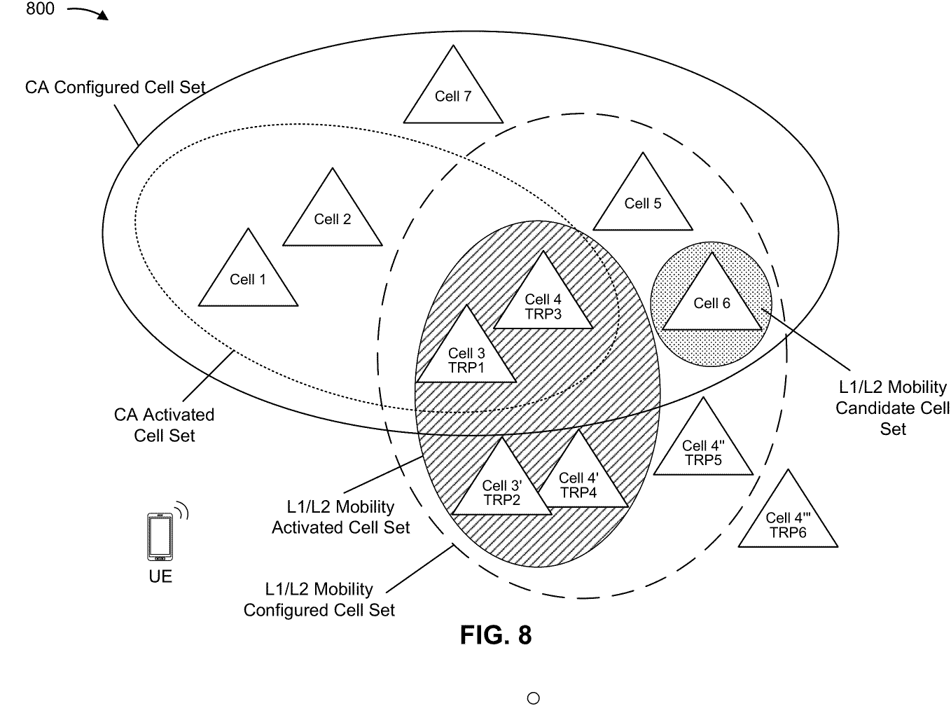

In some aspects, the network node may determine that the one or more conditions are satisfied based at least in part on a TRP being associated with a particular set or group of cells and/or other TRPs. For example, a first group of cells may be configured for carrier aggregation. Within the first group of cells may be a second group of cells with carrier aggregation activated, and a third group of cells with carrier aggregation deactivated. A fourth group of cells may be configured for L1/L2 mobility (e.g., capable of being activated by an L1/L2 signal to become a PCell and/or pTRP). Within the fourth group, a fifth group of cells may have L1/L2 mobility activated, a sixth group of cells may have L1/L2 mobility deactivated, and a seventh group of cells may be an L1/L2 mobility candidate cell set (e.g., configured and capable of being activated). As shown and described further herein (e.g., with reference to FIG. 8), cells may be included in one or more of the foregoing groups based on their configuration, capabilities, channel conditions associated with the UE, and/or the like. In some aspects, the network node may configure the cells in their respective groups. Based on the respective groups, a particular cell (including a particular TRP) may or may not meet one of the conditions to be switched to the PCell and/or aTRP.

As shown by reference number 720, the network node may transmit, and the TRP may receive, the L1/L2 control signal. For example, the network node may send the L1/L2 control signal to cause the TRP to switch from aTRP functionality to pTRP functionality (e.g., if the aTRP is part of the PCell), or to cause the TRP to act as the PCell and enable pTRP functionality (e.g., if the TRP is part of an SCell). In some aspects, the L1/L2 control signal is a MAC CE (e.g., an L2 signal). In some aspects, the L1/L2 control signal is included in DCI (e.g., an L1 signal).

As shown by reference number 725, the TRP may activate pTRP functionality based at least in part on receiving the L1/L2 control signal. In a situation where the TRP is in the PCell, the prior pTRP may become an aTRP (e.g., based on the same or a different L1/L2 control signal). In a situation where the TRP is in an SCell, the SCell becomes the new PCell, and the TRP becomes the pTRP. Other TRPs included in the new PCell may become aTRPs of the new PCell. In some aspects, the pTRP functionality may include functionality associated with the PCell, such as UE-dedicated channels and reference signals for communicating with the UE, responsibility for carrying control information, responsibility for scheduling data communications across multiple component carriers, and/or the like.

In this way, a new pTRP within a PCell may change, and/or an SCell may become a PCell (including activation of a new pTRP) using L1/L2 signaling and without relying on an L3 handover. As a result, the process for changing a pTRP and/or PCell may be more efficient, using fewer resources (including time resources and processing resources), involving fewer devices (e.g., without using a CU to signal a switch), and introducing less latency than other methods, such as an L3 handover. The efficient process, with less latency, may improve network conditions for UEs operating on a network, including a network that uses multi-TRP functionality and carrier aggregation.

As indicated above, FIG. 7 is provided as an example. Other examples may differ from what is described with respect to FIG. 7. For example, while described as being used to switch from aTRP to pTRP functionality, and/or from an SCell to a PCell and pTRP functionality, the same or similar L1/L2 signaling may be used to signal switching from pTRP to aTRP functionality and/or from a PCell to an SCell.

FIG. 8 is a diagram illustrating an example 800 associated with cells with different statuses with respect to carrier aggregation and L1/L2 signaling capabilities and configurations, in accordance with the present disclosure. As shown in FIG. 8, a variety of cells (e.g., network nodes 110, including TRPs) may be included in a coverage area (e.g., network 100) and capable of communicating with a UE (e.g., UE 120).

As shown in the example 800, there are five groupings of cells based on their capabilities and/or configurations. The carrier aggregation configured cell set includes cells (e.g., cell 1, cell 2, cell 3, cell 4, cell 5, cell 6, and cell 7) that are configured for carrier aggregation, as described herein. The carrier aggregation activated cell set includes cells (e.g., cell 1, cell 2, cell 3, and cell 4) that have carrier aggregation active and usable for communications with the UE, as described herein. The L1/L2 mobility configured cell set includes cells (e.g., cell 3, cell 3′, cell 4, cell 4′, cell 4″, cell 5, and cell 6) that are configured for L1/L2 mobility (e.g., configured to switch from aTRP to pTRP and/or from SCell to PCell and pTRP), as described herein. The L1/L2 mobility activated cell set includes cells (e.g., cell 3, cell 3′, cell 4, and cell 4′) that are active as a PCell and/or SCell with TRPs capable of being switched from aTRP to pTRP. The L1/L2 mobility candidate cell set (e.g., cell 6) is configured for L1/L2 mobility and meets conditions for selection as a PCell (e.g., based on channel conditions, cellular loading, and/or the like), but is not yet a PCell or SCell. As shown, some cells are included in multiple sets, though the cells configured for multi-TRP communications (e.g., cell 3 and cell 4) are outside of the carrier aggregation group due to the intra-band communications of each TRP included in the respective multi-TRP cells.

In this example 800, the UE may be in communication with cell 3 as the PCell, which is also identified as TRP 1 and includes TRP 2 as part of the PCell based on multi-TRP functionality. In this situation, the TRP 1 may be provide pTRP functionality, while cell 3′ may provide aTRP functionality. Carrier aggregation may also be in use and activated, enabling multiple component carriers to be used, such that the UE is also in communication with SCells cell 1, cell 2, and cell 4 (including cell 4′ in the same SCell). The UE may also be in communication with cell 3′ and/or cell 4′ as part of multi-TRP communications with cell 3 and cell 4, respectively. In this situation, an L1/L2 control signal may be provided (e.g., by another network node, not shown, such as a CU, DU, base station, and/or the like) that causes the TRPs to switch functionality. For example, if cell 3′ (TRP 2) received the L1/L2 control signal, cell 3′ (TRP 2) may switch from aTRP to pTRP functionality, cell 3 (TRP 1) may switch from pTRP to aTRP functionality, and the PCell remains as cell 3 and cell 3′. If cell 4′ (TRP 4) received the L1/L2 control signal, cell 4 (TRP 3) and cell 4′ become the PCell, and cell 4′ switches to pTRP functionality, while cell 4 (TRP 3) assumes aTRP functionality.

As indicated above, FIG. 8 is provided as an example. Other examples may differ from what is described with respect to FIG. 8. For example, while five groups are shown, more or fewer groups could be configured, activated, and/or in use by a network.

FIG. 9 is a diagram illustrating an example process 900 performed, for example, by a device, in accordance with the present disclosure. Example process 900 is an example where the device (e.g., network node 110, such as a TRP) performs operations associated with L1/L2 signaling for inter-cell mobility with multiple TRPs.

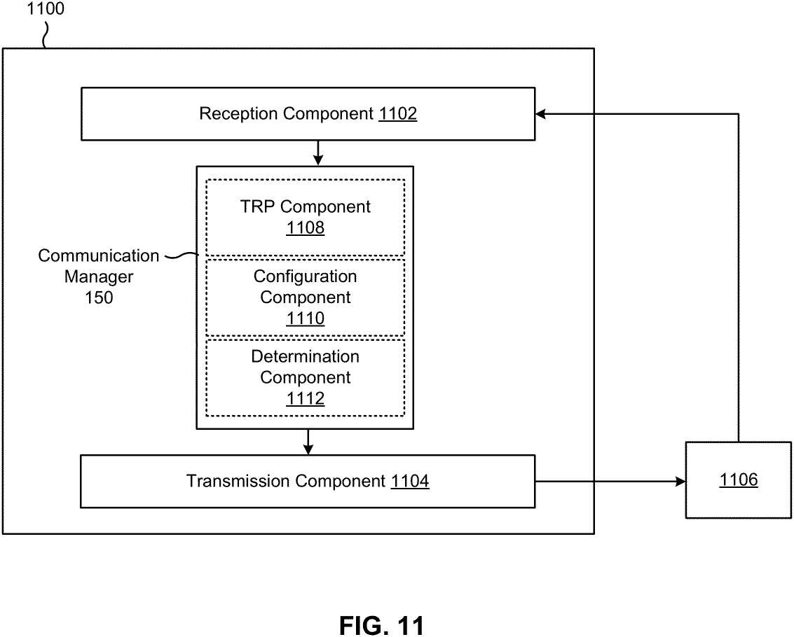

As shown in FIG. 9, in some aspects, process 900 may include receiving configuration information, the configuration information indicating that an L1/L2 control signal is to be used to indicate when the device is to: switch from additional TRP functionality to primary TRP functionality for a primary serving cell, or switch from a secondary serving cell to the primary serving cell and activate the primary TRP functionality (block 910). For example, the device (e.g., using communication manager 150 and/or reception component 1102, depicted in FIG. 11) may receive configuration information, the configuration information indicating that an L1/L2 control signal is to be used to indicate when the device is to switch from additional TRP functionality to primary TRP functionality for a primary serving cell, or switch from a secondary serving cell to the primary serving cell and activate the primary TRP functionality, as described above.

As further shown in FIG. 9, in some aspects, process 900 may include receiving the L1/L2 control signal (block 920). For example, the device (e.g., using communication manager 150 and/or reception component 1102, depicted in FIG. 11) may receive the L1/L2 control signal, as described above.

As further shown in FIG. 9, in some aspects, process 900 may include activating, based at least in part on the L1/L2 control signal, the primary TRP functionality (block 930). For example, the device (e.g., using communication manager 150 and/or TRP component 1108, depicted in FIG. 11) may activate, based at least in part on the L1/L2 control signal, the primary TRP functionality, as described above.

Process 900 may include additional aspects, such as any single aspect or any combination of aspects described below and/or in connection with one or more other processes described elsewhere herein.

In a first aspect, the configuration information is received via an RRC communication.

In a second aspect, alone or in combination with the first aspect, the L1/L2 control signal is received via a MAC CE.

In a third aspect, alone or in combination with one or more of the first and second aspects, the L1/L2 control signal is received via DCI.

In a fourth aspect, alone or in combination with one or more of the first through third aspects, the device is one of multiple TRPs configured for intra-frequency multi-TRP communications and inter-frequency carrier aggregation.

In a fifth aspect, alone or in combination with one or more of the first through fourth aspects, the device is acting as the primary serving cell for communications with another device, and the L1/L2 control signal indicates that the device is to become the primary TRP for further communications with the other device.

In a sixth aspect, alone or in combination with one or more of the first through fifth aspects, the device is acting as the secondary serving cell for communications with another device, and the L1/L2 control signal indicates that the device is to become the primary serving cell and the primary TRP for further communications with the other device.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with L1/L2 signaling for inter-cell mobility with multiple TRPs.

As shown in FIG. 10, in some aspects, process 1000 may include providing configuration information, the configuration information indicating that an L1/L2 control signal is to be used to indicate when a TRP is to: switch from additional TRP functionality to primary TRP functionality for a primary serving cell, or switch from a secondary serving cell to the primary serving cell and activate the primary TRP functionality (block 1010). For example, the network node (e.g., using communication manager 150 and/or transmission component 1104, depicted in FIG. 11) may provide configuration information, the configuration information indicating that an L1/L2 control signal is to be used to indicate when a TRP is to switch from additional TRP functionality to primary TRP functionality for a primary serving cell, or switch from a secondary serving cell to the primary serving cell and activate the primary TRP functionality, as described above.

As further shown in FIG. 10, in some aspects, process 1000 may include determining that one or more conditions for the TRP to switch functionality are satisfied (block 1020). For example, the network node (e.g., using communication manager 150 and/or determination component 1112, depicted in FIG. 11) may determine that one or more conditions for the TRP to switch functionality are satisfied, as described above.

As further shown in FIG. 10, in some aspects, process 1000 may include providing, based at least in part on the determination, the L1/L2 control signal (block 1030). For example, the network node (e.g., using communication manager 150 and/or transmission component 1104, depicted in FIG. 11) may provide, based at least in part on the determination, the L1/L2 control signal, as described above.

Process 1000 may include additional aspects, such as any single aspect or any combination of aspects described below and/or in connection with one or more other processes described elsewhere herein.

In a first aspect, the configuration information is provided via an RRC communication.

In a second aspect, alone or in combination with the first aspect, the L1/L2 control signal is provided via a MAC CE.

In a third aspect, alone or in combination with one or more of the first and second aspects, the L1/L2 control signal is provided via DCI.

In a fourth aspect, alone or in combination with one or more of the first through third aspects, process 1000 includes determining that the TRP is to receive the configuration information based at least in part on one or more of a capability of the TRP, or channeling conditions associated with the TRP, and providing the configuration information based at least in part on determining that the TRP is to receive the configuration information.

In a fifth aspect, alone or in combination with one or more of the first through fourth aspects, the one or more conditions are associated with channel conditions of the primary serving cell.

In a sixth aspect, alone or in combination with one or more of the first through fifth aspects, the TRP is acting as the primary serving cell for communications with a device, and the L1/L2 control signal indicates that the TRP is to become the primary TRP for further communications with the other device.

In a seventh aspect, alone or in combination with one or more of the first through sixth aspects, the TRP is acting as the secondary serving cell for communications with another device, and the L1/L2 control signal indicates that the TRP is to become the primary serving cell and the primary TRP for further communications with the other device.

In an eighth aspect, alone or in combination with one or more of the first through seventh aspects, the TRP is one of multiple TRPs configured for intra-frequency multi-TRP communications and inter-frequency carrier aggregation.

In a ninth aspect, alone or in combination with one or more of the first through eighth aspects, providing the configuration information comprises providing the configuration information to at least two of the multiple TRPs.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150) may include one or more of a TRP component 1108, a configuration component 1110, or a determination component 1112, among other examples.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive configuration information, the configuration information indicating that an L1/L2 control signal is to be used to indicate when the network node is to switch from additional TRP functionality to primary TRP functionality for a primary serving cell, or switch from a secondary serving cell to the primary serving cell and activate the primary TRP functionality. The reception component 1102 may receive the L1/L2 control signal. The TRP component 1108 may activate, based at least in part on the L1/L2 control signal, the primary TRP functionality.

The configuration component 1110 may provide configuration information, the configuration information indicating that an L1/L2 control signal is to be used to indicate when a TRP is switch from additional TRP functionality to primary TRP functionality for a primary serving cell, or switch from a secondary serving cell to the primary serving cell and activate the primary TRP functionality. The determination component 1112 may determine that one or more conditions for the TRP to switch functionality are satisfied. The transmission component 1104 may provide, based at least in part on the determination, the L1/L2 control signal.

The determination component 1112 may determine that the TRP is to receive the configuration information based at least in part on one or more of a capability of the TRP, or channel conditions associated with the TRP.

The transmission component 1104 may provide the configuration information based at least in part on determining that the TRP is to receive the configuration information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a device, comprising: receiving configuration information, the configuration information indicating that an L1/L2 control signal is to be used to indicate when the device is to: switch from additional TRP functionality to primary TRP functionality for a primary serving cell, or switch from a secondary serving cell to the primary serving cell and activate the primary TRP functionality; receiving the L1/L2 control signal; and activating, based at least in part on the L1/L2 control signal, the primary TRP functionality.

Aspect 2: The method of Aspect 1, wherein the configuration information is received via RRC communication.

Aspect 3: The method of any of Aspects 1-2, wherein the L1/L2 control signal is received via a MAC CE.

Aspect 4: The method of any of Aspects 1-3, wherein the L1/L2 control signal is received via DCI.

Aspect 5: The method of any of Aspects 1-4, wherein the device is one of multiple TRPs configured for intra-frequency multi-TRP communications and inter-frequency carrier aggregation.

Aspect 6: The method of Aspect 5, wherein the device is acting as the primary serving cell for communications with another device, and wherein the L1/L2 control signal indicates that the device is to become the primary TRP for further communications with the other device.

Aspect 7: The method of Aspect 5, wherein the device is acting as the secondary serving cell for communications with another device, and wherein the L1/L2 control signal indicates that the device is to become the primary serving cell and the primary TRP for further communications with the other device.

Aspect 8: A method of wireless communication performed by a network node, comprising: providing configuration information, the configuration information indicating that an L1/L2 control signal is to be used to indicate when a TRP is to: switch from additional TRP functionality to primary TRP functionality for a primary serving cell, or switch from a secondary serving cell to the primary serving cell and activate the primary TRP functionality; determining that one or more conditions for the TRP to switch functionality are satisfied; and providing, based at least in part on the determination, the L1/L2 control signal.

Aspect 9: The method of Aspect 8, wherein the configuration information is provided via RRC communication.

Aspect 10: The method of any of Aspects 8-9, wherein the L1/L2 control signal is provided via a MAC CE.

Aspect 11: The method of any of Aspects 8-10, wherein the L1/L2 control signal is provided via DCI.

Aspect 12: The method of any of Aspects 8-11, further comprising: determining that the TRP is to receive the configuration information based at least in part on one or more of: a capability of the TRP, or channel conditions associated with the TRP; and providing the configuration information based at least in part on determining that the TRP is to receive the configuration information.

Aspect 13: The method of any of Aspects 8-12, wherein the one or more conditions are associated with channel conditions of the primary serving cell.

Aspect 14: The method of any of Aspects 8-13, wherein the TRP is acting as the primary serving cell for communications with another device, and wherein the L1/L2 control signal indicates that the TRP is to become the primary TRP for further communications with the other device.

Aspect 15: The method of any of Aspects 8-14, wherein the TRP is acting as the secondary serving cell for communications with another device, and wherein the L1/L2 control signal indicates that the device is to become the primary serving cell and the primary TRP for further communications with the other device.

Aspect 16: The method of any of Aspects 8-15, wherein the TRP is one of multiple TRPs configured for intra-frequency multi-TRP communications and inter-frequency carrier aggregation.

Aspect 17: The method of Aspect 16, wherein providing the configuration information comprises: providing the configuration information to at least two of the multiple TRPs.

Aspect 18: An apparatus for wireless communication at a device, comprising a processor; memory coupled with the processor; and instructions stored in the memory and executable by the processor to cause the apparatus to perform the method of one or more of Aspects 1-7.

Aspect 19 An apparatus for wireless communication at a device, comprising a processor; memory coupled with the processor; and instructions stored in the memory and executable by the processor to cause the apparatus to perform the method of one or more of Aspects 8-17.

Aspect 20: A device for wireless communication, comprising a memory and one or more processors coupled to the memory, the one or more processors configured to perform the method of one or more of Aspects 1-7.

Aspect 21: A device for wireless communication, comprising a memory and one or more processors coupled to the memory, the one or more processors configured to perform the method of one or more of Aspects 8-17.

Aspect 22: An apparatus for wireless communication, comprising at least one means for performing the method of one or more of Aspects 1-7.

Aspect 23: An apparatus for wireless communication, comprising at least one means for performing the method of one or more of Aspects 8-17.

Aspect 24: A non-transitory computer-readable medium storing code for wireless communication, the code comprising instructions executable by a processor to perform the method of one or more of Aspects 1-7.

Aspect 25: A non-transitory computer-readable medium storing code for wireless communication, the code comprising instructions executable by a processor to perform the method of one or more of Aspects 8-17.

Aspect 26: A non-transitory computer-readable medium storing a set of instructions for wireless communication, the set of instructions comprising one or more instructions that, when executed by one or more processors of a device, cause the device to perform the method of one or more of Aspects 1-7.

Aspect 27: A non-transitory computer-readable medium storing a set of instructions for wireless communication, the set of instructions comprising one or more instructions that, when executed by one or more processors of a device, cause the device to perform the method of one or more of Aspects 8-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for wireless communication, comprising:
a memory; and
one or more processors, coupled to the memory, configured to:
receive configuration information, the configuration information indicating that a Layer 1 / Layer 2 (L1/L2) control signal is to be used to indicate when the device is to:
switch from additional transmission reception point (TRP)
functionality to primary TRP functionality for a primary serving cell, or
switch from a secondary serving cell to the primary serving cell and activate the primary TRP functionality;
receive the L1/L2 control signal; and
activate, based at least in part on the L1/L2 control signal, the primary TRP functionality.

2. The device of claim 1, wherein the configuration information is received via radio resource control (RRC) communication.

3. The device of claim 1, wherein the L1/L2 control signal is received via a medium access control control element (MAC CE).

4. The device of claim 1, wherein the L1/L2 control signal is received via downlink control information (DCI).

5. The device of claim 1, wherein the device is one of multiple TRPs configured for intra-frequency multi-TRP communications and inter-frequency carrier aggregation.

6. The device of claim 5, wherein the device is acting as the primary serving cell for communications with another device, and
wherein the L1/L2 control signal indicates that the device is to become the primary TRP for further communications with the other device.

7. The device of claim 5, wherein the device is acting as the secondary serving cell for communications with another device, and
wherein the L1/L2 control signal indicates that the device is to become the primary serving cell and the primary TRP for further communications with the other device.

8. A network node for wireless communication, comprising:
a memory; and
one or more processors, coupled to the memory, configured to:
provide configuration information, the configuration information indicating that a Layer 1 / Layer 2 (L1/L2) control signal is to be used to indicate when a transmission reception point (TRP) is to:
switch from additional TRP functionality to primary TRP
functionality for a primary serving cell, or
switch from a secondary serving cell to the primary serving cell and activate the primary TRP functionality;
determine that one or more conditions for the TRP to switch functionality are satisfied; and
provide, based at least in part on the determination, the L1/L2 control signal.

9. The network node of claim 8, wherein the configuration information is provided via radio resource control (RRC) communication.

10. The network node of claim 8, wherein the L1/L2 control signal is provided via a medium access control control element (MAC CE).

11. The network node of claim 8, wherein the L1/L2 control signal is provided via downlink control information (DCI).

12. The network node of claim 8, wherein the one or more processors are further configured to:
determine that the TRP is to receive the configuration information based at least in part on one or more of:
a capability of the TRP, or
channel conditions associated with the TRP; and
provide the configuration information based at least in part on determining that the TRP is to receive the configuration information.

13. The network node of claim 8, wherein the one or more conditions are associated with channel conditions of the primary serving cell.

14. The network node of claim 8, wherein the TRP is acting as the primary serving cell for communications with another device, and
wherein the L1/L2 control signal indicates that the TRP is to become the primary TRP for further communications with the other device.

15. The network node of claim 8, wherein the TRP is acting as the secondary serving cell for communications with another device, and
wherein the L1/L2 control signal indicates that the device is to become the primary serving cell and the primary TRP for further communications with the other device.

16. The network node of claim 8, wherein the TRP is one of multiple TRPs configured for intra-frequency multi-TRP communications and inter-frequency carrier aggregation.

17. The network node of claim 16, wherein the one or more processors, to provide the configuration information, are configured to:
provide the configuration information to at least two of the multiple TRPs.

18. A method of wireless communication performed by a device, comprising:
receiving configuration information, the configuration information indicating that a Layer 1 / Layer 2 (L1/L2) control signal is to be used to indicate when the device is to:
switch from additional transmission reception point (TRP) functionality to primary TRP functionality for a primary serving cell, or
switch from a secondary serving cell to the primary serving cell and activate the primary TRP functionality;
receiving the L1/L2 control signal; and
activating, based at least in part on the L1/L2 control signal, the primary TRP functionality.

19. The method of claim 18, wherein the configuration information is received via radio resource control (RRC) communication.

20. The method of claim 18, wherein the L1/L2 control signal is received via a medium access control control element (MAC CE).

21. The method of claim 18, wherein the L1/L2 control signal is received via downlink control information (DCI).

22. The method of claim 18, wherein the device is one of multiple TRPs configured for intra-frequency multi-TRP communications and inter-frequency carrier aggregation.

23. The method of claim 22, wherein the device is acting as the primary serving cell for communications with another device, and
wherein the L1/L2 control signal indicates that the device is to become the primary TRP for further communications with the other device.

24. The method of claim 22, wherein the device is acting as the secondary serving cell for communications with another device, and
wherein the L1/L2 control signal indicates that the device is to become the primary serving cell and the primary TRP for further communications with the other device.

25. A method of wireless communication performed by a network node, comprising:
providing configuration information, the configuration information indicating that a Layer 1 / Layer 2 (L1/L2) control signal is to be used to indicate when a transmission reception point (TRP) is to:
switch from additional TRP functionality to primary TRP functionality for a primary serving cell, or
switch from a secondary serving cell to the primary serving cell and activate the primary TRP functionality;
determining that one or more conditions for the TRP to switch functionality are satisfied; and
providing, based at least in part on the determination, the L1/L2 control signal.

26. The method of claim 25, wherein the configuration information is provided via radio resource control (RRC) communication.

27. The method of claim 25, wherein the L1/L2 control signal is provided via a medium access control control element (MAC CE).

28. The method of claim 25, wherein the L1/L2 control signal is provided via downlink control information (DCI).

29. The method of claim 25, further comprising:
determining that the TRP is to receive the configuration information based at least in part on one or more of:
a capability of the TRP, or
channel conditions associated with the TRP; and
providing the configuration information based at least in part on determining that the TRP is to receive the configuration information.

30. The method of claim 25, wherein the one or more conditions are associated with channel conditions of the primary serving cell.
